(19) United States
(12) Patent Application Publication
(10) Pub. No.: US 2013/0194416 A1
(43) Pub. Date: Aug. 1, 2013

(54) METHOD AND SYSTEM OF ARCHIVING VIDEO TO FILM

(71) Applicants: Chris Scott Kutcka, Pasadena, CA (US); Joshua Pines, San Francisco, CA (US); William Gibbens Redmann, Glendale, CA (US); Vince Cerundolo, Pasadena, CA (US); Robert Paul Schneider, Agoura Hills, CA (US)

(72) Inventors: Chris Scott Kutcka, Pasadena, CA (US); Joshua Pines, San Francisco, CA (US); William Gibbens Redmann, Glendale, CA (US); Vince Cerundolo, Pasadena, CA (US); Robert Paul Schneider, Agoura Hills, CA (US)

(73) Assignee: Thomson Licensing, Issy de Moulineaux (FR)

(21) Appl. No.: 13/878,648

(22) PCT Filed: Oct. 14, 2011
(86) PCT No.: PCT/US11/56265

§ 371 Date: Apr. 10, 2013

Related U.S. Application Data
(60) Provisional application No. 61/393,858, filed on Oct. 15, 2010.
(60) Provisional application No. 61/393,865, filed on Oct. 15, 2010.

(51) Int. Cl. H04N 5/87

(52) U.S. Cl. CPC H04N 5/87
USPC 348/104; 386/326

(57) ABSTRACT

A method and system are disclosed for archiving video content to film and recovering the video from the film archive. Video data corresponding to the content and a characterization pattern associated with the data are provided as encoded data, which is recorded onto a film for producing a film archive. The characterization pattern contains spatial, temporal and colorimetric information relating to the video data, and provides a basis for recovering the video content from the film archive.

### CROSS-REFERENCE TO RELATED APPLICATIONS

The present patent application claims the benefit of priority from U.S. Provisional Patent Application Ser. No. 61/393,858, “Method and System of Archiving Video to Film”, and from U.S. Provisional Patent Application Ser. No. 61/393,865, “Method and System for Producing Video Archive On Film”, both filed on Oct. 15, 2010. The teachings of these provisional patent applications are expressly incorporated herein by reference in their entirety.

### TECHNICAL FIELD

The present invention relates to a method and system of creating film archives of video content, and recovering the video content from the film archives.

### BACKGROUND

Although there are many media formats that can be used for archival purpose, film archive still has advantages over other formats, including a proven archival lifetime of over fifty years. Aside from degradation problems, other media such as video tape and digital formats may also become obsolete, with potential concerns as to whether equipment for reading the magnetic or digital format are still available in the future.

Tradition methods for transferring video to film involve photographing video content on a display monitor. In some cases, this means photographing color video displayed on a black and white monitor through separate color filters. The result is a photograph of the video image. A telecine is used for retrieving or recovering the video image from the archive photograph. Each frame of film is viewed by a video camera and the resulting video image can be broadcast live, or recorded. The drawback to this archival and retrieval process is that the final video is “a video camera's image of a photograph of a video display”, which is not the same as the original video.

Recovery of video content from this type of film archive typically requires manual, artistic intervention to restore color and original image quality. Even then, the recovered video often exhibit spatial, temporal and/or colorimetric artifacts. Spatial artifacts can arise due to different reasons, e.g., if there is any spatial misalignment in displaying the video image, in the photographic capture of the video display, or the video camera capture of the photographic archive.

Temporal artifacts can arise from photographs of an interlaced video display due to the difference in time at which adjacent line pairs are captured. In cases where the video frame rate and film frame rates are not 1:1, the film images may produce temporal artifacts resulting from the frame rate mismatch, e.g., telecine judder. This can happen, for example, when the film has a frame rate of 24 frames per second (fps) and video has a frame rate of 60 fps (in US) or 50 fps (in Europe), and one frame of a film is repeated for two or more video frames.

Additionally, colorimetric artifacts are introduced because of metamerisms between the display, film, and video camera, i.e., different colors generated by the display can appear as the same color to the film, and again different colors in the archive film can appear as the same color to the video camera.

### SUMMARY OF THE INVENTION

These problems in the prior art approach are overcome in a method of the present principles, in which the dynamic range of the film medium is used to preserve digital video data in a self-documenting, accurately recoverable, degradation resistant, and human-readable format. The video recovered from this archival format has essentially no perceptible spatial, temporal, and colorimetric artifacts when compared with the original video, and requires no human intervention for color restoration or gamut remapping.

One aspect of the invention provides a method for archiving video content on film, which includes: encoding digital video data and a characterization pattern associated with the digital video data to form encoded data, where the encoded data includes film density codes corresponding to the digital video data; recording the encoded data onto film in accordance with the film density codes; and producing a film archive from the film having the recorded encoded data.

Another aspect of the invention provides a method for recovering video content from a film archive, which includes: scanning at least a portion of the film archive containing film-based data corresponding to digital video data and a characterization pattern associated with the digital video data; and recovering the video content from the film archive based on the characterization pattern.

Yet another aspect of the invention provides a system for archiving video content on film, including: an encoder for producing encoded data containing film-based data corresponding to digital video data and a characterization pattern associated with the digital video data; a film recorder for recording the encoded data onto a film; and a film processor for processing the film to produce a film archive.

Yet another aspect of the invention provides a system for recovering video content from a film archive, including: a film scanner for scanning the film archive to produce film-based data; a decoder for identifying a characterization pattern from the film-based data, and for decoding the film-based data based on the characterization pattern to produce video data for use in recovering the video content.

### BRIEF DESCRIPTION OF THE DRAWINGS

The teachings of the present invention can be understood by considering the following detailed description in conjunction with the accompanying drawings (not to scale), in which:

FIG. 1A illustrates a system for archiving video content to film;

FIG. 1B illustrates a system for recovering video content previously archived to film;

FIG. 2 illustrates a sequence of progressive frames of video content on a film archive;

FIG. 3 illustrates a sequence of field-interlaced frames of video content on a film archive;

FIG. 4A illustrates a characterization pattern for use at a header of a field-interlaced frame of video content on a film archive;

FIG. 4B is an expanded view of a portion of FIG. 4A;

FIG. 5 illustrates a characterization pattern for use with progressive frames of video content stored in a film archive;

FIG. 6 illustrates a characterization pattern for use with field-interlaced frames of video content stored in a film archive;

FIG. 7 illustrates a process for creating a film archive of video content according to one aspect of the present invention;

FIG. 8 illustrates a process for recovering video from a film archive according to another aspect of the present invention; and

FIG. 9A-B illustrate characteristics curves for some film stocks.

To facilitate understanding, identical reference numerals have been used, where possible, to designate identical elements that are common to the figures.

### DETAILED DESCRIPTION

The present principles provide a method and system for producing a film archive of video content, and for recovering the video content from the archive. The archive is produced by recording encoded data onto film, which is then developed to provide an archival quality storage medium. The encoded data includes encoded video content along with a characterization pattern associated with the video content. The video content can be recovered by scanning the film archive, with the characterization pattern providing a basis for decoding the film frames to video. Subsequent decoding of the film frame scan data produces video substantially identical to the original video, even in the presence of many decades of fading of the film dyes. The characterization pattern may include instructions sufficient for a technician to recover the original video with no other specialized knowledge of the encoding or format.

Unlike prior art techniques that renders video content as a picture recorded on film, e.g., by taking a picture of each video frame displayed on a monitor using a kinescope or cine camera, the archive production system of the present invention treats the video signal as numerical data, which can be recovered with substantial accuracy by using the characterization pattern.

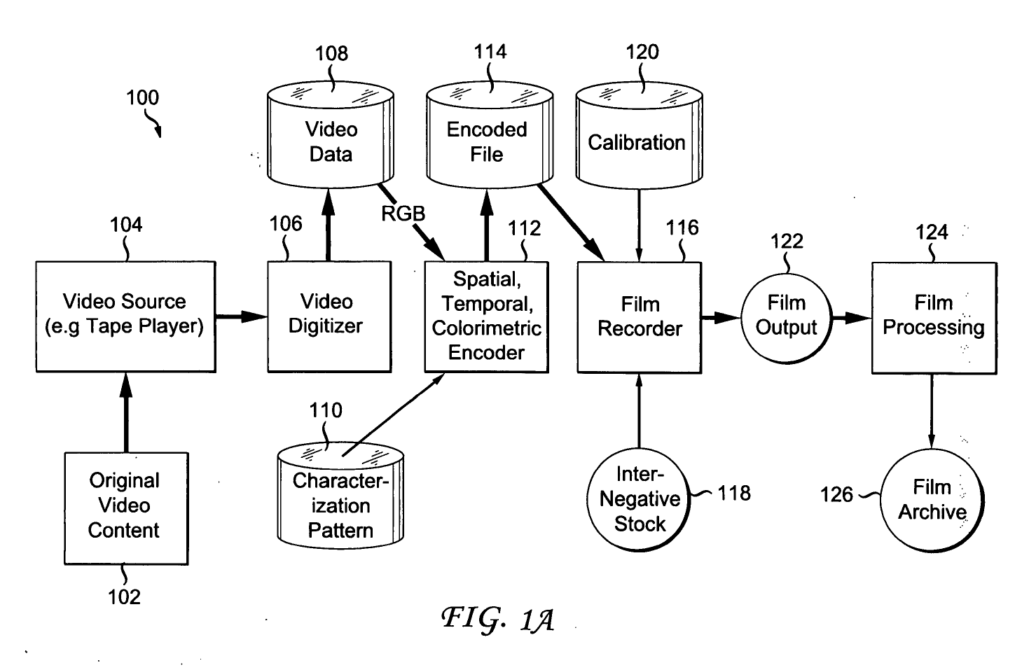

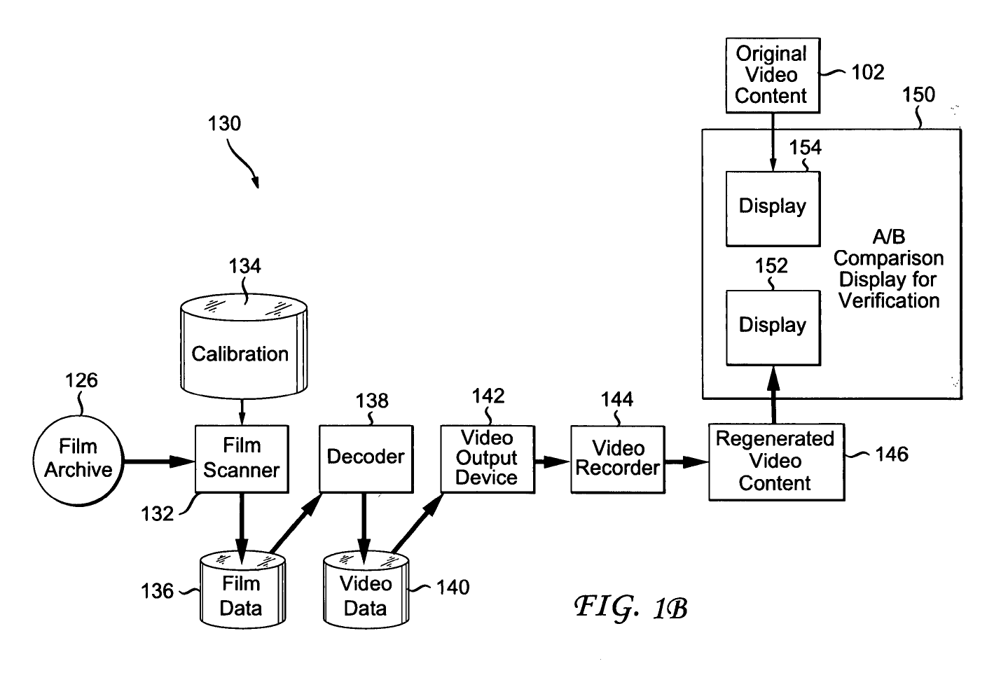

FIG. 1A shows one embodiment of a film archive system 100 of the present invention, which includes an encoder 112 for providing an encoded file 114 containing video content 108 and a characterization pattern 110, a film recorder 116 for recording the encoded file, and a film processor 124 for processing the recorded file and producing a film archive 126 of the video content. As used herein in conjunction with the overall activities of encoder 112, the term “encoding” includes transforming from video data format into film data format, e.g., from Rec. 709 codes (representing fractional contributions of the three video display primaries) to film density codes (representing respective densities of three dyes in a film negative, e.g., Cineon code, with values in the range of 0 to 1023), and spatial and temporal formatting (e.g., as pixels in the video data 108 and characterization pattern 110 are mapped to appropriate pixels in the image space of the film recorder 116). In this context, temporal formatting refers to the mapping of pixels from the video to the film image space in accordance with the time sequence of the video data, e.g., with consecutive pictures in the video being mapped into consecutive frames of film. For progressive video, individual video frames are recorded as single film frames, while interlaced video is recorded as separate fields, e.g., the odd rows of pixels forming one field and the even rows of pixels forming another field, with the separate fields of a frame recorded within the same film frame.

Original video content 102 is provided to the system 100 via a video source 104. Examples of such content include television shows presently stored on video tape, whether in digital or analog form. The video source 104 (e.g., a videotape player), suitable for use with the format of original video content 102, provides the content to video digitizer 106 to produce video data 108. In one embodiment, video data 108 is in, or convertible to, RGB (red, green, blue) code values because they result in negligible artifacts compared to other formats. Although video data 108 can be provided to the encoder 112 in non-RGB formats, e.g., as luminance and chrominance values, various imperfections and crosstalk in the archiving and video conversion processes using these formats can introduce artifacts in the recovered video.

Video data 108 can be provided by digitizer 106 in different video formats, including, for example, high-definition formats such as “Rec. 709”, which provide a convention for encoding video pixels using numerical values. According to the Rec. 709 standard (Recommendation BT.709, published by the International Telecommunications Union, Radiocommunication Sector, or ITU-R, of Geneva, Switzerland), a compatible video display will apply a 2.4-power function (also referred to as having a gamma of 2.4) to the video data, such that a pixel with an RGB code value x (e.g., from digitizer 106), when properly displayed, will produce a light output proportional to x^{2.4}. Other video standards provide other power functions, for example, a monitor compliant with the sRGB standard will have a gamma of 2.2. If the video content from the source is already provided in digital form, e.g., the SDI video output (“Serial Digital Interface”) on professional grade video tape players, the video digitizer 106 can be omitted.

In some configurations, the original video content 102 may be represented as luminance and chrominance values, i.e., in YCrCb codes (or, for an analog representation, YPrPb), or other encoding translatable into RGB code values. Furthermore, original video content 102 may be sub-sampled, for example 4:2:2 (where for each four pixels, luminance “Y” is represented with four samples, but the chromatic components “Cr” and “Cb” are each sampled only twice), reducing the bandwidth required by ⅓, without significantly affecting image quality.

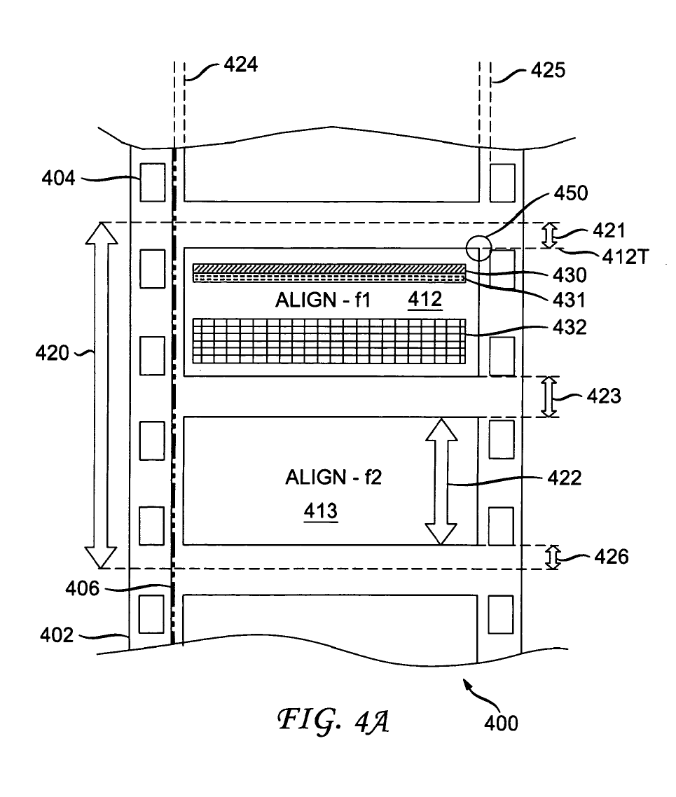

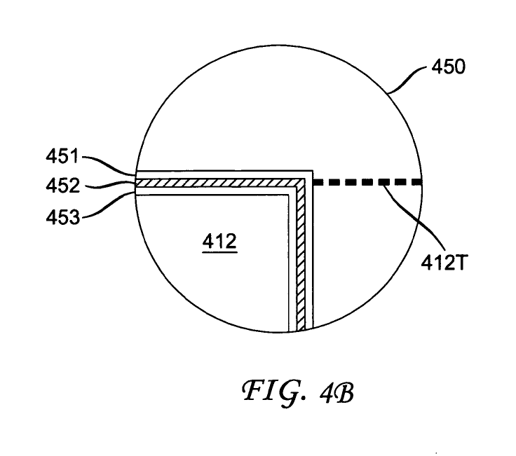

Characterization pattern 110, which is associated with the video data of the content, and to be discussed in greater detail below in conjunction with FIGS. 4A-B, 5 and 6, is provided to the encoder 112 to establish the spatial, colorimetric, and/or temporal configurations (or at least one of these configurations) of an archive at the time of its creation.

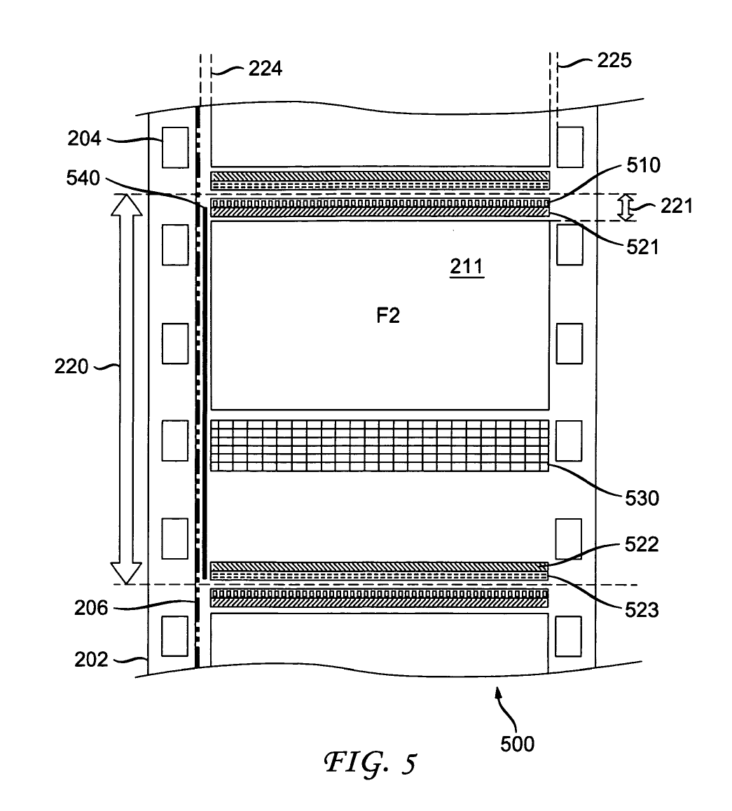

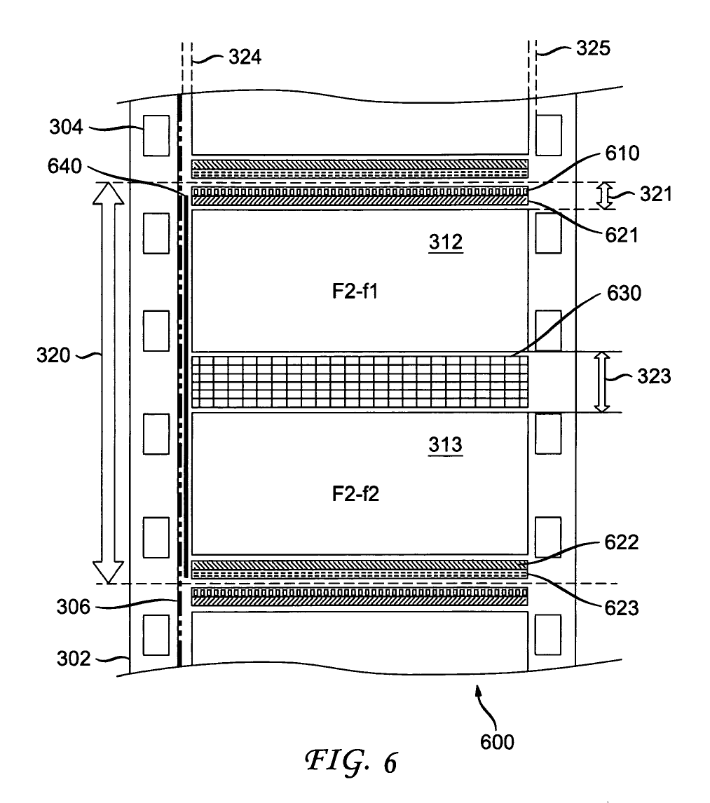

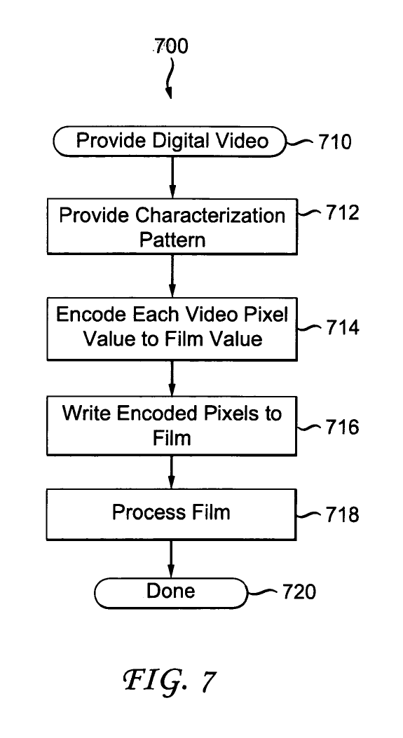

Encoder 112 encodes video data 108 in accordance with information in the characterization pattern 110, including spatial, temporal and colorimetric information. The encoding of the video data includes transforming or converting the video data 108 from a digital format (e.g., Rec. 709 or others) to a film-based format such as film density codes. In one example, this conversion is done based on a substantially linear relationship between the digital and film-based code values. Encoded file 114 includes characterization pattern 110 and the video data 108 encoded with spatial and temporal information according to the characterization pattern. It is also possible to include only a portion of the characterization pattern in the encoded file, as long as there is sufficient information available to a decoder for decoding the film archive. In encoded file 114, characterization pattern 110 may be positioned ahead of the encoded video data (e.g., FIGS. 4A-B), or may be provided in the same frame as the encoded video data (e.g., FIGS. 5-6).

The spatial and temporal encoding by encoder 112 is presented in characterization pattern 110, which indicates where each frame of video information is to be found in each frame of the archive. If interlaced fields are present in video content 102, then characterization pattern 110 also indicates a spatial encoding performed by encoder 112 of the temporally distinct fields.

Such information can be provided as data or text contained in the pattern 110, or based on the pattern's spatial configuration or layout, either of which is appropriate for machine or human readability. For example, pattern 110 may contain text that relates to location and layout of the image data, e.g., saying, “Image data is entirely within, and exclusive of, the red border” (e.g., referring to FIG. 4B, element 451), and such specific information can be particularly helpful to a person unfamiliar with the archive format. Text can also be used to annotate the pattern, for example, to indicate the format of the original video, e.g., “1920×1080, interlaced, 60 Hz,” and time-code for each frame can be printed (where at least a portion of the calibration pattern is being provided periodically throughout the archive).

Furthermore, specific elements (e.g., boundaries or indicating lines) can be used to indicate to encoder 112 the physical extent or positions of data, and the presence of two such elements corresponding to two data regions in a frame (or one double-height element), can be used to indicate the presence of two fields to be interlaced per frame.

In another embodiment, data such as a collection of binary values may be provided as light and dark pixels, optionally combined with geometric reference marks (indicating a reference frame and scale for horizontal and vertical coordinates). Such a numerically based position and scale can be used instead of graphically depicting borders for data regions. Such a binary pattern can also represent appropriate SMPTE time-code for each frame.

With respect to the colorimetric encoding by encoder 112, characterization pattern 110 includes patches forming a predetermined spatial arrangement of selected code values. The selected code values (e.g., video white, black, gray, chroma blue, chroma green, various flesh tones, earth tones, sky blue, and other colors) could be selected because they are either crucial for correct technical rendering of an image, important to human perceptions, or exemplary of a wide range of colors. Each predetermined color would have a predetermined location (e.g., where that color will be rendered within the patch) so the decoder knows where to find it. The code values used for these patches are selected to substantially cover the full extent of video code values, including values at or near the extremes for each color component, so as to allow interpolation or extrapolation of the non-selected values with adequate accuracy, especially if the coverage is sparse. Subsets of the patches supplied in characterization pattern 110 may present color components separately or independently of other components, i.e., with the value of the other components being fixed or at zero) and/or in varying combinations (e.g., grey scales where all components have the same value; and/or different collections of non-grey values).

One use of characterization pattern 110 presenting components separately is to allow an easy characterization of linearity and fading of color dyes as an archive has aged, along with any influence of dye crosstalk. However, patches with various combinations of color components can also be used to convey similar information. The spatial arrangement and code values of color patches in the characterization pattern are made available to a decoder for use in recovering video from the film archive. For example, information regarding the position (absolute or relative to a reference position) of a patch and its color or code value representation will allow the decoder to properly interpret the patch, regardless of intervening problems with overall processing variations or archive aging.

Whether video digitizer 106 produces code values in RGB, or some other representation, the video data 108 includes code values that are, or can be converted to, RGB code values. The RGB code values are typically 10 bit representations, but the representations may be smaller or larger (e.g., 8-bits or 12-bits).

The range of RGB codes of video data 108 (e.g., as determined by the configuration of the video digitizer 106, or a processing selected when converted to RGB, or predetermined by the representation of the original video content 102 or video source 104) should correspond to the range of codes represented in characterization pattern 110. In other words, the characterization pattern preferably covers at least the range of codes that the video pixel values might be using, so that there is no need to extrapolate the range. (Such extrapolation is unlikely to be very accurate. For example, if the pattern covers codes in a range of 100-900, but the video covers a range of 64-940, then in the end sub-ranges 64-100 and 900-940 of the video, there is a need to extrapolate from the nearest two or three neighbors (which might be, say, every hundred counts). The problem arises from having to estimate a conversion for video code 64 based on conversions for video codes 100, 200, and 300, etc., which assumes that the film behavior at video code 64 is responding to light in a way similar to how it responds at video codes 100, 200, etc., which, is probably not the case because a film's characteristic curve typically has non-linear response near the low and high exposure limits.

For example, if characterization pattern 110 uses 10-bit code values, and if the coding for video data 108 was only 8-bits, then as part of the encoding operation by encoder 112, video data 108 may be left-shifted and padded with zeroes to produce 10-bit values, where the eight most significant bits correspond to the original 8-bit values. In another example, if the characterization pattern 110 uses fewer bits than the representation of video data 108, then the excess least significant bits of video data 108 can be truncated (with or without rounding) to match the size of the characterization pattern representation.

Depending on the specific implementation or design of the pattern, incorporation of the characterization pattern 110 into encoded file 114 can provide self-documenting or self-sufficient information for interpretation of an archive, including the effects of age on the archive. For example, the effects of age can be accounted for based on colorimetric elements such as a density gradient, since elements in the characterization pattern would have the same aged effect as images in the film archive. If color patterns are designed to represent the entire color range for the video content, it is also possible to decode the pattern algorithmically or heuristically, without the decoder having prior knowledge or predetermined information regarding the pattern. In another embodiment, text instructions for archive interpretation can be included in the characterization pattern, so that a decoder can decode the archive without prior knowledge about the pattern.

The encoded file 114, whether stored in a memory device (not shown) and later recalled or streamed in real-time as encoder 112 operates, is provided to film recorder 116, which exposes color film stock 118 in accordance with the encoded file data to produce film output 122 (i.e., exposed film) having the latent archive data, which is developed and fixed in chemical film processor 124 to produce film archive 126.

The purpose of film recorder 116 is to accept a density code value for each pixel in encoded file 114 and produce an exposure on film stock 118 that results in a specific color film density on film archive 126, which is produced by film processor 124. To improve the relationship or correlation between code value presented to the film recorder 116 and the resulting density on the film archive, film recorder 116 is calibrated using data 120 from a calibration procedure. The calibration data 120, which can be provided in a lookup table for converting film density code to film density, depends on the specific manufacture of film stock 118 and the expected settings of the film processor 124. To the extent that film stock 118 has any non-linearity in its characteristic curves, i.e., the relationship between log₁₀ exposure (in lux-seconds) and density (which is the log₁₀ of the reciprocal of the transmissivity), calibration data 120 produces a linearization such that a given change in density code value produces a fixed change in density, across the entire range of density code values. Furthermore, the calibration data may include a compensation matrix for crosstalk in the dye sensitivity.

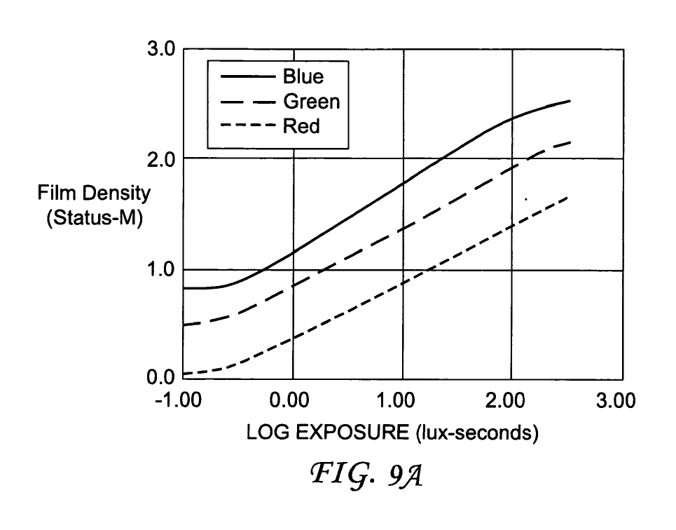

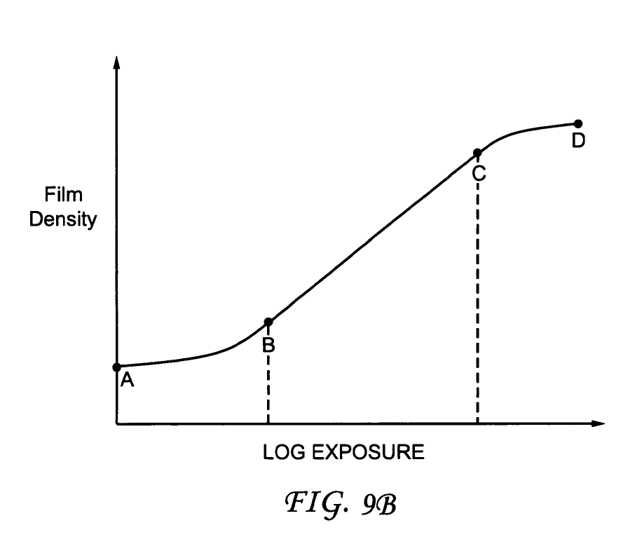

In one embodiment, film stock 118 is an intermediate film stock (e.g., Eastman Color Internegative II Film 5272, manufactured by Kodak of Rochester, N.Y.), especially one designed for use with a film recorder (e.g., Kodak VISION3 Color Digital Intermediate Film 5254, also by Kodak), and is engineered to have a more linear characteristic curve. FIG. 9A shows the characteristic curves for this film for the blue, green and red colors at certain exposure and processing conditions.

Other types of film stocks may be used, with different corresponding calibration data 120. FIG. 9B shows another example of a characteristic curve (e.g., for one color) for these stocks, which may exhibit a shorter linear region, i.e., a smaller range of exposure values within the linear region BC, compared to that of FIG. 9A. In addition, the characteristic curve has a more substantial (e.g., over a larger range of exposures) “toe” region AB with diminished film sensitivity at low exposures, i.e., a smaller slope in the curve where an incremental exposure produces a relatively small incremental density compared to the linear region BC, and a “shoulder” region CD at higher exposures, with a similarly diminished film sensitivity as a function of exposure. For these stocks, the overall characteristic curve has a more pronounced sigmoidal shape. Nonetheless, corresponding calibration data 120 can be used to linearize the relationship between pixel code value and density to be recorded on the film archive. However, the resulting film archive 126 will be more sensitive to variations in the accuracy of film recorder 116 and film processor 124. Furthermore, since the linear region BC of this characteristic curve is steeper than that of the Kodak Internegative II Film 5272, i.e., the variation in density will be greater for a given incremental change in exposure, such stock will be more prone to noise in this intermediate region (and less so in the low or high exposure regions).

Thus, to generate a film archive, a numeric density code value ‘c’ from encoded file 114 (e.g., corresponding to the amount of red primary in the color of a pixel) is provided to film recorder 116 for conversion to a corresponding film-based parameter, e.g., film density (often measured in units called “status-M”), based on calibration data 120. The calibration provides a precise, predetermined linear relationship between density code value ‘c’ and a resulting density. In one commonly used example, the film recorder is calibrated to provide an incremental density of 0.002 per incremental code value. Exposures required for generating desired film densities are determined from the film characteristic curve (similar to FIGS. 9A-B) and applied to the film stock, which results in a film archive after processing by the film processor 124. To retrieve the video content from the film archive, film densities are converted back into the code values ‘c’ by a calibrated film scanner, as discussed below in the archive retrieval system of FIG. 1B.

FIG. 1B shows an example of an archive reading or retrieval system 130 for recovering video from a film archive, e.g., film archive 126 produced by archive production system 100. Film archive 126 may have recently been made by film archive system 100, or may have aged substantially (i.e., archive reading system 130 may be operating on archive 126 some fifty years after the creation of the archive).

Film archive 126 is scanned by film scanner 132 to convert film densities to film data 136, i.e., represented by density code values. Film scanner 132 has calibration data 134, which, similar to calibration data 120, is a collection of parameter values (e.g., offsets, scalings, which may be non-linear, perhaps a color look-up table of its own) that linearizes and normalizes the response of the scanner to film density. With a calibrated scanner, densities on film archive 126 are measured and produce linear code values in film data 136, i.e., an incremental code value represents the same change in density at least throughout the range of densities in film archive 126. In another embodiment, calibration data 134 may linearize codes for densities throughout the range of densities measurable by film scanner 132. With a properly calibrated scanner (e.g., with a linear relationship between density code values and film densities), an image portion recorded with a density corresponding to a code value ‘C’ from the encoded file 114 is read or measured by scanner 132, and the resulting numeric density code value, exclusive of any aging effects or processing drift, will be about equal to, if not exactly, ‘C’.

To establish the parameters for spatial and temporal decoding, decoder 138 reads and examines film data 136 to find the portion corresponding to characterization pattern 110, which is further examined to identify the locations of data regions, i.e., regions containing representations of video data 108, within film data 136. This examination will reveal whether the video data 108 includes a progressive or interlaced raster, and where the data regions corresponding to the frames or fields are to be found.

Based on prior knowledge or information relating to, or obtained from, the characterization pattern, decoder 138 recognizes which density code values in film data 136 correspond to original pixel codes in characterization pattern 110, and a look-up table is created within decoder 138. For example, prior knowledge relating to the pattern may be predetermined or provided separately to the decoder, or information may be included in the pattern itself, either explicitly or known by convention. The look-up table, which may be sparse, is created specifically for use with decoding film data 136. Subsequently, density code values read in portions of film data 136 corresponding to video content data can be decoded, i.e., converted into video data, using this look-up table, including by interpolation, as needed.

Thus, video data is extracted and colorimetrically decoded by decoder 138 from film data 136, whether field-by-field or frame-by-frame, as appropriate. Recovered video data 140 is read by video output device 142, which can format the video data 140 into a video signal appropriate to video recorder 144 to produce regenerated video content 146.

Video recorder 144 may, for example, be a video tape or digital video disk recorder. Alternatively, in lieu of video recorder 144, a broadcast or content streaming system may be used, and recovered video data 140 can be directly provided for display without an intermediate recorded form.

As a quality check or a demonstration of the effectiveness of the archive making and archive reading systems 100 and 130, original video content 102 and regenerated video content 146 may be examined with video comparison system 150, which may include displays 152 and 154 to allow an operator to view the original video and the recovered video in a side-by-side presentation. In another embodiment of comparison system 150, an A/B switch can alternate between showing one video and then the other on a common display. In still another embodiment, the two videos can be shown in a “butterfly” display, which presents one half of an original video and a mirror image of the same half of the recovered video on the same display. Such a display offers an advantage over a dual (e.g., side-by-side) display because corresponding parts of the two videos are presented in similar surroundings (e.g., with similar contrasts against their respective backgrounds), thus facilitating visual comparison between the two videos. The video content 146 generated from the film archive according to the present invention will be substantially identical to that of original video content 102.

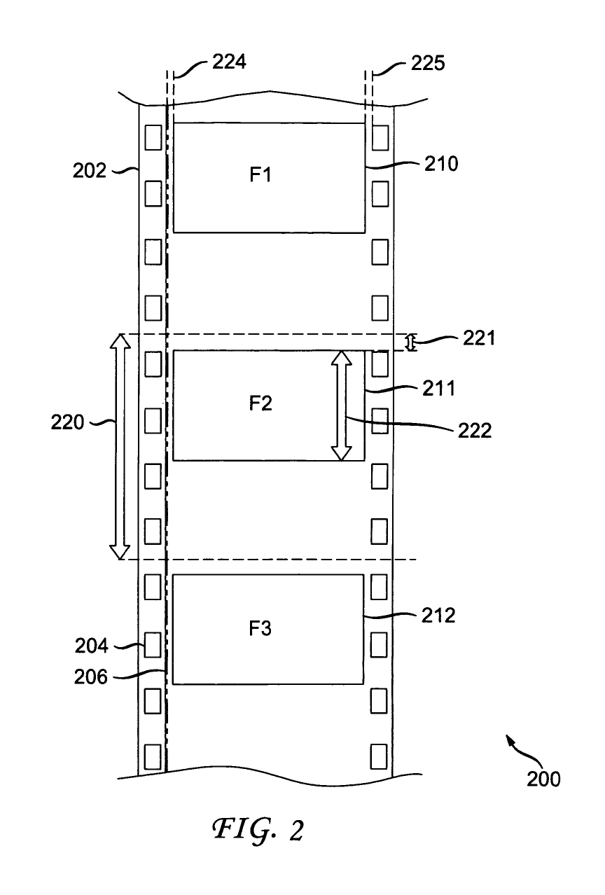

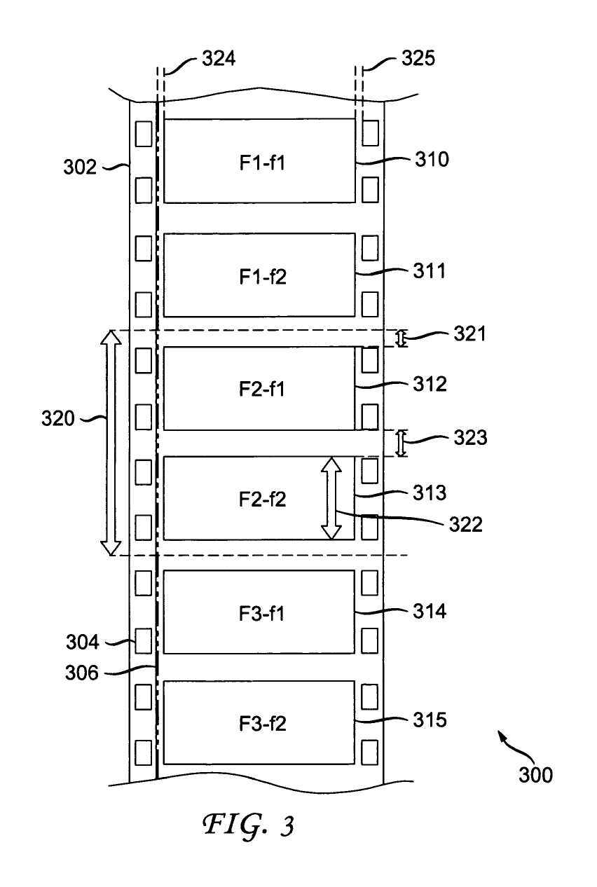

FIG. 2 and FIG. 3 show exemplary embodiments of frames of video data encoded within a film archive 126. In film archive 200, several progressive scan video frames are encoded as frames F1, F2 and F3 on the film, and in film archive 300, interlaced scan video frames are encoded as separated, successive fields such as F1-f1, F2-f2, and so on, where F1-f1 and F1-f2 denote different fields f1, f2 within the same frame F1. Film archives 200 and 300 are stored or written on film stock 202 and 302, respectively, with corresponding perforations such as 204 and 304 for establishing the respective position and interval of exemplary film frames 220 and 320. Each film archive may have an optional soundtrack 206, 306, which can be analog or digital or both, or a time code track (not shown) for synchronization with an audio track that is archived separately.

The data regions 210, 211 and 212 of film archive 200, and data regions 310, 311, 312, 313, 314 and 315 of film archive 300 contain representations of individual video fields that are spaced within their corresponding film frames (frames 220 and 320 being exemplary). These data regions have horizontal spacings 224, 225, 324, 325 from the edge of the corresponding film frames, vertical spacings 221, 321 from the beginning of the corresponding film frames, vertical heights 222 and 322, and interlaced fields have inter-field separation 323. These parameters or dimensions are all identified by the spatial and temporal descriptions provided in characterization patterns, and are described in more detail below in conjunction with FIGS. 4A-B and 5-6.

FIG. 4A shows a characterization pattern 110 recorded as a header 400 within film archive 126, and in this example, for original video content 102 having interlaced fields. Film frame height 420, is the same length as a run of four perforations (illustrated as perforation 404), forming a conventional 4-perforation (“4-perf”) film frame. In an alternative embodiment, a different integer number of film perforations might be selected as the film frame height.

In the illustrated embodiment, within each 4-perf film frame, data regions 412 and 413 contain representations of two video fields (e.g., similar to fields 312, 313 in film archive 300), and may be defined by their respective boundaries. In this example, each boundary of the data region is denoted by three rectangles, as shown in more detail in FIG. 4B, which represents a magnified view of region 450 corresponding to corner portions of rectangles 451, 452 and 453 forming the boundary of data region 412. In other words, the rectangle in FIG. 4A having corner region 450 includes three rectangles: 451, 452, and 453, which are drawn on film 400 as pixels, e.g., with each rectangle being one pixel thick. Rectangle 452 differs in color and/or film density from its adjacent rectangles 451 and 453, and is shown by a hash pattern. In this example, the data region for field 412 includes pixels located on or within rectangle 452 (i.e., region 412 interior to rectangle 452, including those in rectangle 453), but excluding those in rectangle 451 or those outside. Rectangle 451 can be presented in an easily recognizable color, e.g., red, to facilitate detection of the boundary between data versus non-data regions.

Thus, in each respective data-containing frame of film archive 300, the first and second fields (e.g., F2-f1 and F2-f2) are laid out with the corresponding film frame (e.g., frame 320) exactly as regions 412 and 413 are laid out (including out to boundary rectangle 452) within characterization pattern frame 420. In this embodiment, film recorder 116 and film scanner 132 are required to accurately and repeatably position film stock 118 and film archive 126, respectively, to ensure reproducible and accurate mapping of the encoded file 114 into a film archive, and from the film archive into film data 136 during video recovery.

Thus, when read by scanner 132, rectangles 451-453 specify precisely the location or boundary of the first field in each film frame. The film recorder and film scanner operate on the principle of being able to position the film relative to the perforations with sub-pixel accuracy. Thus, relative to the four perfs 304 of film 300, each first field (e.g., F1-f1, F2-f2 and F3-f1) has the same spatial relationship to the four perfs of its frame as do the other odd fields, and likewise for the second fields F1-f2, F2-f2 and F3-f2. This identical spatial relationship holds true with the characterization pattern 400, which defines the regions where the first fields and second fields are located. Thus, region 412, as represented by its specific boundary configuration (such as rectangles 451, 452 and 453) specifies locations of first fields F1-f1, F2-f1 and F3-f1, and so on.

Similarly, rectangles around data region 413 would specify where individual second fields (e.g., F1-f2, F2-f2 and F3-f2) are to be found. For a progressive scan embodiment, a single data region with corresponding boundary (e.g., rectangles similar to those detailed in FIG. 4B) would specify where progressive frame video data regions (e.g., 210-212) would be found within subsequent film frames (e.g., 220).

The top 412T of first field 412 is shown in both FIGS. 4A and 4B, and defines head gap 421. Along with side gaps 424 and 425, and a tail gap 426 below region 413, top gap 421 is selected to ensure that data regions 412 and 413 lie sufficiently inset within film frame 420 such that film recorder 116 can reliably address the entirety of data regions 412 and 413 for writing, and film scanner 132 can reliably access the entirety of the data regions for reading. The presence of inter-field gap 423 (shown in exaggerated proportion compared to first and second fields 412 and 413) in archives of field-interlaced video content, assures that each field can be stored and recovered precisely and distinctly, without introducing significant errors in the scanned images that might arise from misalignment of the film in the scanner. In another embodiment, it is possible to have no inter-field gap 423, i.e., a gap that is effectively zero, with the two fields abutting each other. However, without an inter-field gap 423, a misalignment in the scanner can result in pixels near an edge of one field being read or scanned as pixels of an adjacent field.

The characterization pattern in film frame 420 includes, for example, colorimetric elements 430-432. The colorimetric elements may include a neutral gradient 430, which, in one example, is a 21-step grayscale covering a range of densities from the minimum to maximum in each of the color dyes (e.g., from a density of about 0.05 to 3.05 in steps of about 0.15, assuming such densities are achievable from film stock 118 within new film archive 126). As previously mentioned, a density gradient can be used as a self-calibrating tool for the effects of aging. For example, if the bright end (i.e., minimum density) of gradient 430 is found to be 10% denser when scanned sometime in the future, decoder 138 can correct for such aging effects by reducing the lightest or lowest densities in the archive film by a corresponding amount. If the dark end (i.e., maximum density) of the gradient is 5% less dense, then similar dark pixels in the archive film will be increased by a corresponding amount. Furthermore, a linear interpolation for any density value can be made based on two readings from the gradient, and by using additional readings across gradient 430, the system can compensate for non-linear aging effects.

The colorimetric elements may also include one or more primary or secondary color gradient 431, which, in one example, is a 21-step scale from about minimum density to maximum density of substantially only one dye (for measuring primary colors) or two dyes (to measure secondary colors). Similar to that described above for the neutral density gradient, density drifts arising from aging of individual dyes can also be measured and compensation provided.

For a more complete characterization, the colorimetric elements may include a collection of patches 432 which represent specific colors. An exemplary collection of colors would be generally similar those found in the ANSI IT8 standards for color communications and control, e.g., IT8.7/1 R2003 Graphic Technology—Color Transmission Target for Input Scanner Calibration, published by the American National Standards Institute, Washington, D.C., that are normally used to calibrate scanners; or the Munsell ColorChecker marketed by X-Rite, Inc. of Grand Rapids, Mich. Such colors emphasize a more natural portion of a color gamut, providing color samples more representative of flesh tones and foliage than would either grayscales or pure primary or secondary colors.

The characterization pattern may be provided in the header of a single film frame 420. In an alternative embodiment, the characterization pattern of frame 420 may be reproduced identically in each of several additional frames, with the advantage being that noise (e.g., from a dirt speck affecting the film recording, processing or scanning) can be rejected on the basis of multiple readings and appropriate filtering. In still another embodiment, the characterization pattern may be provided in the header over multiple film frames (not shown) in addition to film frame 420, for example to provide still more characterization information (e.g., additional color patches or stepped gradients). For example, a characterization pattern may include a sequence of different test patterns provided over a number film frames, e.g., a test pattern in a first frame for testing grayscale, three different test patterns in three frames for testing individual colors (e.g., red, green and blue, respectively), and four more frames with test patterns covering useful foliage and skin tone palettes. Such a characterization pattern can be considered as one that extends over eight frames, or alternatively, as different characterization patterns provided in eight frames.

FIGS. 5 and 6 show alternative embodiments in which respective characterization patterns (e.g., pattern 110 of FIG. 1) are recorded so as to be distributed and recurring throughout the corresponding film archives over a number of film frames. FIG. 5 shows a characterization pattern in a portion of a film archive 500 for progressive scan video (similar to that in FIG. 2), and FIG. 6 shows a characterization pattern in a portion of a film archive 600 for field-interlaced video (similar to that in FIG. 3). The video archived according to the present invention will have information relating to the spatial, temporal, and colorimetric properties provided or embedded as characterization pattern in the same film frames that contain the data regions. By repeating the readings or measurements of various properties (e.g., colors and/or densities) in different frames throughout the scan of the film archive, aging effects in the film can be properly corrected for, because the effects of aging may vary as a function of locations in the roll of film (e.g., the outer windings of the roll may have experienced larger temperature swings than the interior of the reel).

In the film archives 500 and 600, the corresponding characterization patterns include column indicators 510 and 610 for indicating the width of the data regions 211 and 312/313 respectively. In these examples, column indicators 510 and 610 are located in top gap 221 and 321, respectively. Each column indicator 510 and 610 may include, for example, a horizontal bar of a color detectably distinct from the surrounding area. The left- and right-ends of the horizontal bar indicate the left and right extremes or limits of the data regions, thereby defining the precise width or separation between left-side gap 224 and right-side gap 225 of archive 500, and the separation between left-side gap 324 and right-side gap 325 of archive 600. Column indicators 510 and 610 may have markers or vertical stripes to indicate specific columns, which can be used to compensate for any difference between the non-linearities in the horizontal pixel positions written by a film recorder 116 and read by scanner 132.

As an example, assume that a film recorder has a non-linearity along the horizontal direction, such that columns of pixels are written with x pixels/mm near an edge of a frame, and y pixels/mm near the center (where x and y are integers, and y is greater than x), and the film archive is read out by a scanner without non-linearity in the horizontal direction, e.g., at z pixels/mm from edge to center (where z is an integer between x and y). If the difference in the non-linearity between the recorder and scanner is not compensated for, then an image object moving across the screen would appear to be stretched near the edge, i.e., from x pixels to z pixels per mm, and compressed near the center, i.e., from y pixels to z pixels per mm. By providing column markers such as 510 and 610 across the top of a frame, e.g., a tick mark at periodic column intervals, any nonlinearities present in the archive film (arising from the film recorder) and the film scanner can be tracked and compensated for in the recovered video.

For example, the column markers and the pixels in the columns themselves can be written by one machine (e.g., film recorder) having certain distortions, and read back by another machine (e.g., film scanner) having different distortions. However, since a given column marker is transformed through the same distortions as each pixel in the column, the data can be recoverable without distortion (i.e., the distortion can be corrected or compensated for) since each column's original position, i.e., position of the pixel from the source video, is definitively labeled by the marker (e.g., if using Gray code, the marker can be used to label the column by number). Alternatively, the marker can also be used to simulate a pixel clock, as in a series of light and dark pixels.

Similarly, row indicators 540 and 640 are used to specify where individual scan lines of video are recorded within film frames 220 and 320. In these examples, row indicators 540 and 640 are located in left-side gaps 224 and 324, respectively. In one embodiment, row indicators 540 and 640 can be a bar, similar to column indicators 500 and 600, but oriented for determining or indicating the vertical extent of the data regions. This embodiment may use stripes to better identify individual scan lines. In another embodiment, the row indicators 540 and 640 may include a binary Gray code allowing distinct numbering of each scan line of the data regions, and perhaps elsewhere within the film frame. Rather than tick marks every third column or so, a Gray code could be used to number individual columns.

Colorimetric elements or indicators 521-523 and 530 are provided within film frame 220, and colorimetric indicators 621-623, and 630 are provided within film frame 320, but outside respective data regions 211, 312, 313 and column/row indicators 510, 540, 610 and 640. These elements can be placed in many different locations outside the data regions, including any or all of top gaps 221, 321 (e.g., neutral density gradients 521, 621), intra-field gap 323 (e.g., color patch set 630), or at the bottom of the film frame but below the data regions, e.g., patches 530, or gradients 522, 523, 622, 623. These density gradients and patches can be configured with properties similar to those discussed in connection with FIG. 4A.

In some frames of film archives 500, 600, the colorimetric elements of corresponding characterization pattern 110 may be repeated, i.e., with identical elements being used or provided in different frames, which may include inserting the same characterization pattern in consecutive frames or at various intervals throughout the film archive. Alternatively, different colorimetric elements may be provided in separate frames. For example, in film archive 600, if more color patches like 630 are desirable than will fit in intra-field gap 323, then different or additional patches can be provided in a number of consecutive frames. Likewise, the density gradients may be varied over consecutive frames. If characterization pattern 110 is designed to have the colorimetric elements vary over multiple consecutive frames, then the variations may form a cycle that is repeated occasionally or continuously throughout the archive 500, 600. Such repetition of the colorimetric elements of the characterization pattern can provide continuous characterization throughout the roll of film forming the archive 126. This allows the video recovery system 130 to compensate for any differential variations that may be present between the head and tail of the roll (e.g., as might occur if the temperature of the developer tank in film processor 124 was rising as film output 122 was being processed; or if archive 126 had been stored in a room having significant temperature swings that accelerated dye fade at the outer portion of the film rolls in archive 126 more than the inner portion).

FIG. 7 shows a process 700 for creating a film archive of video content. Process 700, which can be implemented by a film archive system such as that in FIG. 1A, begins at step 710, with digital video data 108 being provided to an encoder 112. In step 712, a corresponding characterization pattern 110 associated with the video data is also provided. The characterization pattern, which has a format compatible with the encoder (and also compatible with a decoder for recovering the video), can be provided as a text file with information relevant to the video data, or as image(s) to be incorporated with the video frames, e.g., pre-pending as headers or be included or as composite with one or more frames of image data, but in readable/writable regions not containing image data such as intra-frame gap regions. The characterization pattern includes one or more elements designed for conveying information relating to at least one of the following: video format, time codes for video frames, location of data regions, color or density values, aging of film archive, non-linearities or distortions in film recorder and/or scanner, among others.

In step 714, all pixel values of the video data and characterization pattern are encoded to produce encoded data 114, which are film density code values (e.g., Cineon code) corresponding to the respective pixel values. In one embodiment, the film density code values and the respective pixel values are related via a substantially linear relationship. Depending on the layout described by the characterization pattern, the characterization pattern and video data may both be present or co-resident in one or more frames of encoded data 114, or the pattern and video data may occupy separate frames (e.g., as in the case of pre-pending the pattern as headers).

In step 716, the encoded file data is written with film recorder 116 to a film stock 118. In one embodiment, the recorder is calibrated based on a linear relationship between film density codes (e.g., Cineon codes) and film density values, and latent images are formed on the film negative by proper exposures according to respective film density codes or corresponding file density values.

In step 718, the exposed film stock is processed or developed using known or conventional techniques to produce film archive 126 at step 720.

Note that in this process 700, the film archive may not be suitable for producing a high quality film print, because any non-linear relationship between video pixel values (from original video data) and the film density codes may not have been taken into account in the encoded data file.

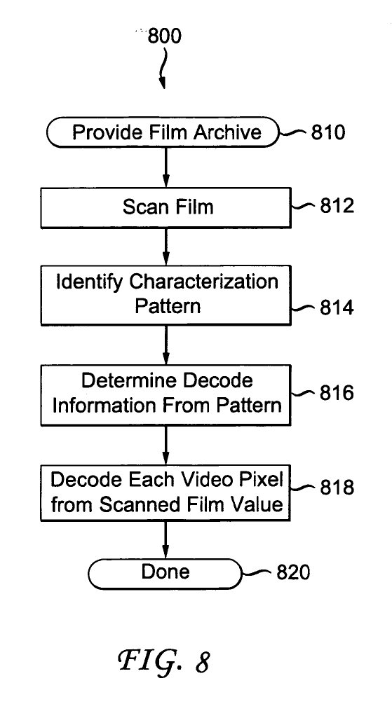

FIG. 8 illustrates a process 800 for recovering video content from a film archive (such as archive 126 produced by process 700) in accordance with the present principles. Process 800 can be implemented in a system such as the example of FIG. 1B. In step 810, a film archive (which can be an “aged” archive) is provided for scanning in step 812 by a film scanner 132 to produce film data 136, i.e., measured density on the film archive is converted into a corresponding density code. Depending on the specific archive and characterization pattern, it is not necessary to scan or read the entire film archive, but instead, at least one or more data regions, i.e., portions containing data corresponding to the video content. For example, if the characterization pattern contains only spatial and temporal information about the video data (no colorimetric information), then it may be possible to identify the correct video data portions without even having to scan the characterization pattern itself. Similar to the film recorder, the scanner has also been calibrated based on a linear relationship between density codes and film density values.

In step 814, based on prior knowledge regarding the characterization pattern, decoder 138 picks out or identifies the record of the characterization pattern 110 from film data 136. In step 816, the decoder uses the characterization pattern, and/or other prior knowledge relating to the configuration of various elements (e.g., certain patches corresponding to a grayscale gradient starting at white and proceeding in ten linear steps, or certain patches representing a particular order set of colors), to determine decoding information appropriate to the film data, including the specification for the location and timing of data regions, and/or colorimetry. In step 818, the decoding information is used to decode data regions within the film archive, i.e., converting the data from film density codes to produce video data, from which the video is recovered at step 820.

Other variations of the above process may involve omitting the characterization pattern, or a portion thereof, from the film archive, even though it is used for encoding purpose and provided in the encoded file. In this case, additional information may be needed for a decoder to properly decode the film archive. For example, if the position of images and the densities are prescribed by a standard, then there is no need to include the characterization pattern in the film archive. Instead, prior knowledge of the standard or other convention will provide the additional information for use in decoding. In this and other situations that do not require scanning the characterization pattern, step 814 in process 800 may be omitted. Another example may involve including only a portion of the pattern, e.g., color patches, in the film archive. Additional information for interpreting the patches can be made available to the decoder, separate from the film archive, for decoding the archive.

While the forgoing is directed to various embodiments of the present invention, other embodiments of the invention may be devised without departing from the basic scope thereof. For example, one or more features described in the examples above can be modified, omitted and/or used in different combinations. Thus, the appropriate scope of the invention is to be determined according to the claims that follow.

1. A method for archiving video content on film, comprising:
encoding digital video data and a characterization pattern associated with the digital video data to form encoded data, wherein the encoded data includes film density codes corresponding to the digital video data;
recording the encoded data onto film in accordance with the film density codes; and
producing a film archive from the film having the recorded encoded data.

2. The method of claim 1, wherein the encoding is performed in accordance with the characterization pattern.

3. The method of claim 1, wherein the characterization pattern provides at least one of temporal, spatial and colorimetric information relating to the digital video data.

4. The method of claim 1, wherein the characterization pattern includes at least one of time codes for video frames, elements indicating location of video data on the film archive, and color patches representing predetermined pixel code values.

5. The method of claim 1, wherein the characterization pattern includes at least one of data, text and graphics elements.

6. The method of claim 1, wherein the characterization pattern further comprises:
at least one of a density gradient and color patches representing different color components.

7. The method of claim 1, wherein the characterization pattern is provided in at least one frame not containing any video data.

8. The method of claim 1, wherein the characterization pattern is provided in at least one frame containing video data.

9. The method of claim 1, wherein the encoding step further comprises converting the digital video data into film density codes based on a substantially linear relationship.

10. The method of claim 1, wherein the film archive contains a plurality of frames each corresponding to a frame of progressive video.

11. The method of claim 1, wherein the film archive contains a plurality of frames, each having two fields representing respective odd and even rows of pixels of a frame of interlaced video.

12. The method of claim 1, wherein the encoded data is provided in RGB code values.

13. A method for recovering video content from a film archive, including:
scanning at least a portion of the film archive containing film-based data corresponding to digital video data and a characterization pattern associated with the digital video data; and
recovering the video content from the film archive based on the characterization pattern.

14. The method of claim 13, wherein the recovering step comprises:
determining decoding information from the characterization pattern; and
converting the film-based data to digital video data based on the decoding information.

15. The method of claim 14, wherein the converting step is performed based on a linear relationship between the film-based data and the digital video data.

16. The method of claim 13, wherein the characterization pattern provides at least one of temporal, spatial and colorimetric information relating to the digital video data.

17. The method of claim 13, wherein the characterization pattern includes at least one of time codes for video frames, elements indicating location of digital video data on the film archive, and color patches representing predetermined pixel code values.

18. The method of claim 13, wherein the film-based data corresponding to digital video data is represented by film density values.

19. A system for archiving video content on film, comprising:
an encoder for producing encoded data containing film-based data corresponding to digital video data and a characterization pattern associated with the digital video data;
a film recorder for recording the encoded data onto a film; and
a film processor for processing the film to produce a film archive.

20. A system for recovering video content from a film archive, comprising:
a film scanner for scanning the film archive to produce film-based data;
a decoder for identifying a characterization pattern from the film-based data, and for decoding the film-based data based on the characterization pattern to produce video data for use in recovering the video content.
